(19) United States
(12) Patent Application Publication
(10) Pub. No.: US 2024/0237613 A1
(43) Pub. Date: Jul. 18, 2024

(54) PET TOY

(71) Applicant: DoggyMan H. A. Co., Ltd., Osaka (JP)

(72) Inventor: Yasushi Nishida, Osaka-shi (JP)

(73) Assignee: DoggyMan H. A. Co., Ltd., Osaka (JP)

(21) Appl. No.: 18/411,828

(22) Filed: Jan. 12, 2024

(30) Foreign Application Priority Data
Jan. 17, 2023 (JP) 2023-004948

(51) Int. Cl. A01K 15/02

(52) U.S. Cl. CPC A01K 15/025

(57) ABSTRACT

The present invention provides a pet toy that can adjust the diameter and amount of pet food that comes out according to the pet's movements. The pet toy of the present invention includes a body having a first opening and a second opening and accommodating pet food, a first cap attached to the first opening and having a first hole, and a second cap that is attached to the body and has a second hole, and as the body rotates or locomotes, the pet food in the body is discharged from at least one of the first cap and the second cap. It is characterized by being released.

### TECHNICAL FIELD

The present invention relates to a pet toy that allows pets such as dogs and cats to play with and to feed them.

### BACKGROUND ARTS

For example, Patent Literature 1 (Utility Model Registration No. 3021991) discloses a pet toy with feeding device wherein a cylinder of an appropriate length is made with an appropriate hole, and the pet uses its own ability and body to roll the cylinder, allowing the food to come out one by one from the hole. Such a pet toy with feeding device is simple in that no matter how the pet handles the toy with feeding device, the food comes out one by one from the hole.

### PRIOR ART

### Patent Literature

Patent Literature 1: Utility Model Registration No. 3021991

### SUMMARY OF THE INVENTION

### Problems to be Solved by the Invention

Accordingly, an object of the present invention is to provide a pet toy that can feed and adjust the diameter and amount of a pet food that comes out according to the movement of the pet.

### Means for Solving the Problems

In order to solve the above problem, the present invention provides a pet toy characterized by comprising:
a body having a first opening and a second opening and accommodating a pet food,
a first cap attached to the first opening and having a first hole, and
a second cap attached to the second opening and having a second hole;
wherein the pet food in the body is released from at least one of the first cap and the second cap when rotating or locomoting the body.

In the pet toy of the present invention, it is preferable that the body is approximately cylindrical, and the first opening and the second opening are located at both ends of the body.

Further, in the pet toy of the present invention, it is preferable that the first cap has a first cover that freely opens and closes the first hole.

Furthermore, in the pet toy of the present invention, it is preferable that the second cap has a second cover that freely opens and closes the second hole.

Further, in the pet toy of the present invention, it is preferable that the first cap further has a third hole, and the first cover selectively covers one of the first hole and the third hole.

Further, in the pet toy of the present invention, it is preferable that the second cap further has a fourth hole, and the second cover selectively covers one of the second hole and the fourth hole.

### Effects of the Invention

According to the pet toy of the present invention, the pet food accommodated in the body is released from at least one of the first cap and the second cap according to the rotation and locomotion of the body due to contact with the pet. Therefore, the pet toy of the present invention can also be called a pet feeding device. According to the pet toy of the present invention, since the diameter and amount of the pet food that comes out can be adjusted according to the movements of the pet, it is possible to strongly attract the interest of the pet. In addition, since the pet can learn how to release the pet food by moving the pet toy of the present invention in various ways, the pet toy can be suitably used for educational purposes.

### BRIEF EXPLANATION OF DRAWINGS

FIGS. 1(A) and (B) are a front view and an exploded view of the pet toy 1 according to a typical embodiment of the present invention.

FIGS. 2(A) to 2(D) are a front perspective view and a rear perspective view of the pet toy 1 with holes 51 and 71 exposed, and a longitudinal cross-sectional view of the caps 5 and 7.

FIGS. 3(A) to 3(D) are a front perspective view and a rear perspective view of the pet toy 1 with the holes 51 and 71 closed, and a longitudinal cross-sectional view of the caps 5 and 7.

FIGS. 4(A) to 4(C) are a front perspective view, a rear perspective view, and a longitudinal sectional view showing the other cap 15.

FIGS. 5(A) to 5(C) are a front perspective view, a rear perspective view, and a longitudinal sectional view showing the other cap 25.

FIGS. 6(A) and 6(B) are diagrams showing an example of how the pet P plays with the pet toy 1.

### PREFERRED EMBODIMENTS

In the following, the typical embodiments of the pet toy according to the present invention are explained in detail by referring the drawings. However, the present invention is not limited to these drawings. Since the drawings are to use for explaining the present invention conceptually, for showing the present invention clearly, there is a case where sizes, ratios or number may be shown in the exaggerated or simplified manner, as occasion demand.

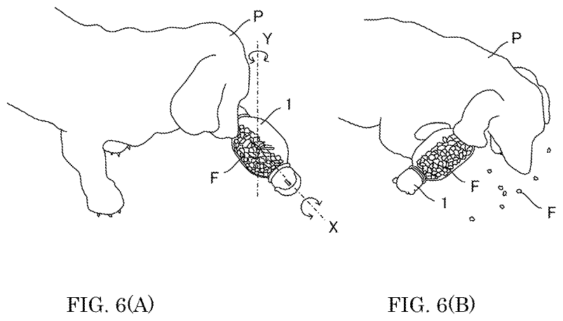

In the present embodiment, the pet P that uses the pet toy 1 is assumed to be, for example, dogs or cats (see FIGS. 6(A) and 6(B)), but is not limited thereto.

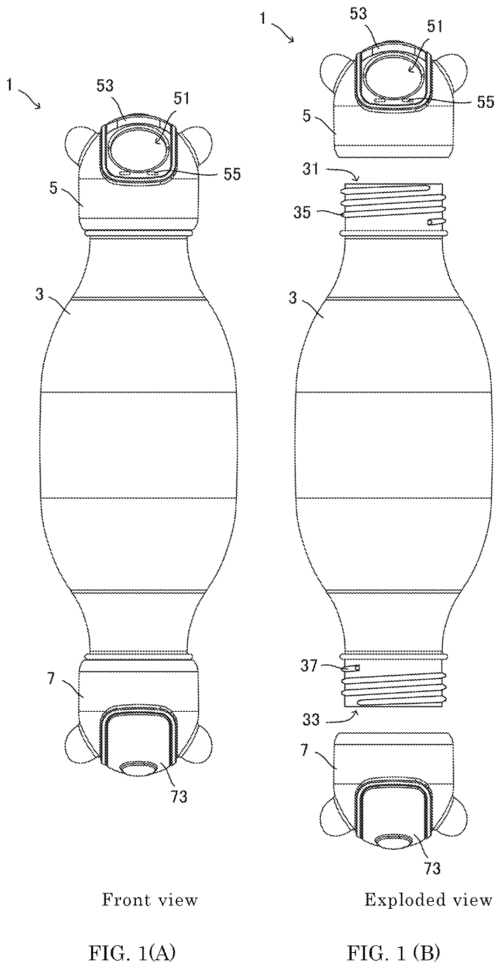

For example, as shown in FIG. 1(A), the pet toy 1 includes a body 3 and caps 5 and 7. These components will be explained in detail below.

The body 3 is a hollow container that accommodates the pet food F (see FIGS. 6(A) and 6(B)). The pet food F is preferably in the form of granules or powder, but is not limited to these, and may be in the form of pellets, tablets, or pills. It is preferable that dry granular or powdered pet food F is accommodated, so that the pet P is interested in dry food because the dry food makes noise when the body 3 rotates or locomotes. The body 3 has openings 31 and 33 (corresponding to the first opening and the second opening) for putting in and taking out the pet food F (see FIG. 1(B)).

It is preferable that the body 3 has a substantially cylindrical shape, and the openings 31 and 33 are located at both ends thereof. Here, the term substantially cylindrical shape includes shapes where the center part is curved or convex outward (shape like a rugby ball), and shapes where the center part is concave inward (bone toy shape). The body 3 may be curved as a whole, or may be bent into a substantially V-shape or a substantially L-shape.

Further, the cross-sectional shape may be any shape as long as the body 3 can be rotated or locomoted, and may be, for example, circular, elliptical, polygonal, etc.

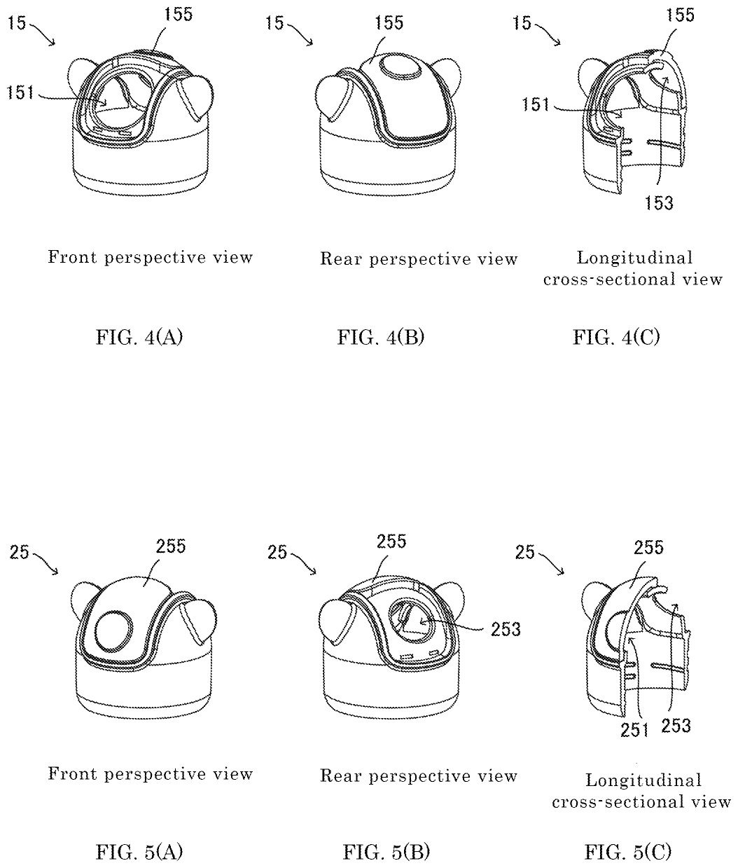

The openings 31 and 33 have a substantially cylindrical shape and have screw threads 35 and 37 on their outer peripheral surfaces that engage with the inner peripheral surfaces of the caps 5 and 7 (see FIG. 1(B)). It is preferable that the dimensions of the openings 31, 33 are substantially the same, which allows attachment of various types of caps (see, for example, FIG. 4(A) to FIG. 5(C)).

Further, the openings 31 and 33 may have an irregular shape (ellipse, polygon, etc.). In this case, the caps 5 and 7 may be engaged in a fitting manner.

The body 3 is suitably made of a resin material such as polyethylene terephthalate (PET). Therefore, the body 3 deforms when pressed by the pet P, and restores to the original shape when the pressure is removed. The body 3 is preferably transparent so that the pet P can visually recognize the pet food F in the pet toy 1 (see FIGS. 6(A) and 6(B)).

Next, the caps 5 and 7 will be explained.

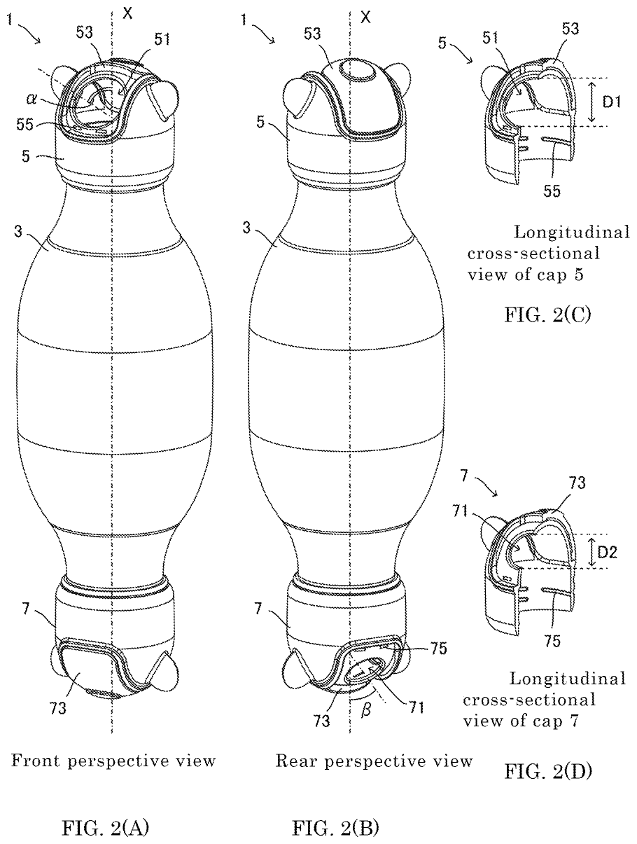

The cap 5 corresponds to the first cap, and is attached to the opening 31 (or opening 33) as shown in FIGS. 1(A) and (B). For example, as shown in FIG. 2(C), the cap 5 has a hole 51 (corresponding to the first hole) having a diameter D1 (corresponding to the first diameter). The hole 51 allows the pet food F in the body 3 smaller than the diameter D1 to pass therethrough.

It is preferable that the plane of the hole 51 (the plane including the edge of the hole 51) be inclined by a predetermined angle α° with respect to the X-axis direction connecting the openings 31 and 33 of the body 3 (see FIG. 2(A)). As a result, when the pet food F in the body 3 moves forcefully toward the cap 5 due to the centrifugal force that acts when the body 3 rotates, a portion of the pet food F collides with the cap 5 and stays within the pet toy 1. Therefore, it is effectively suppressed that a large amount of the pet food F is released from the hole 51 at once. Preferably, the predetermined angle α° is, for example, 35° to 55°, but is not limited thereto.

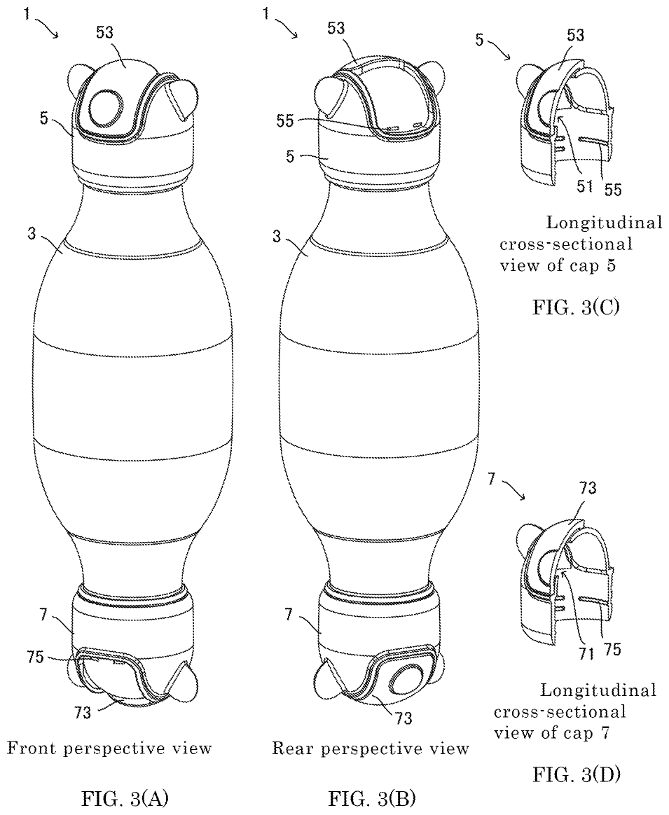

The cap 5 may have a cover 53 (corresponding to the first cover) that covers the hole 51 in an openable and closable manner (see, for example, FIG. 2(A) and FIG. 3(A)). By closing the cover 53, unintended release of the pet food F can be prevented or the released amount of the pet food F can be adjusted. For example, the cover 53 can be configured as a shutter that opens and closes the hole 51 by sliding on the cap 5 (see FIG. 2(C) and FIG. 3(C)).

It is preferable that the cap 5 has a holding mechanism 55 that holds the cover 53 in an open state and a closed state (see FIG. 1(B)). The holding mechanism 55 can be composed of, for example, protrusions and corresponding recesses.

A thread groove 55 (also be usable as the holding mechanism 55 of the cover 53) is formed on the inner circumferential surface of the cap 5 to engage with the opening 31 of the body 3 (screw thread 35 on the outer circumferential surface thereof). Therefore, the cap 5 can be easily attached to and removed from the opening 31 of the body 3, which is convenient for cleaning the parts including the body 3 and for replenishing (filling) the body 3 with the pet food F.

Next, the cap 7 corresponds to the second cap, and is attached to the opening 33 as shown in FIGS. 1(A) and 1(B). For example, as shown in FIG. 2(D), the cap 7 has a hole 71 (corresponding to the second hole) having a diameter D2 (corresponding to the second diameter) smaller than the diameter D1, and in the present embodiment, the relation of D1>D2 is established. Therefore, the hole 71 would not pass the pet food F which can pass the hole 51 but has a diameter larger than the diameter D2. In this way, the size of the pet food F to be released can be adjusted by the holes 51 and 71.

It is preferable that the plane of the hole 71 (the plane including the edge of the hole 71) be inclined by a predetermined angle β° with respect to the X-axis direction (see FIG. 2(B)). As a result, when the pet food F in the body 3 moves forcefully toward the cap 7 due to the centrifugal force that acts when the body 3 rotates, a portion of the pet food F collides with the cap 7 and stays within the pet toy 1. Therefore, it is effectively suppressed that a large amount of the pet food F is released from the hole 71 at once. Preferably, the predetermined angle β° is, for example, 35° to 55°, but is not limited thereto.

The cap 7 may have a cover 73 (corresponding to the second cover) that covers the hole 71 in an openable and closable manner (see, for example, FIG. 2(B) and FIG. 3(B)). By closing the cover 73, unintended release of the pet food F can be prevented or the released amount of the pet food F can be adjusted. For example, the cover 73 can be configured as a shutter that opens and closes the hole 71 by sliding on the cap 7 (see FIG. 2(D) and FIG. 3(D)).

It is preferable that the cap 7 has a holding mechanism 75 that holds the cover 73 in an open state and a closed state (see FIGS. 2(A) and 2(B)). The holding mechanism 75 can be composed of, for example, protrusions and corresponding recesses.

A thread groove 75 (also be usable as the holding mechanism 75 of the cover 73) is formed on the inner circumferential surface of the cap 7 to engage with the opening 33 of the body 3 (screw thread 37 on the outer circumferential surface thereof). Therefore, the cap 7 can be easily attached to and removed from the opening 33 of the body 3, which is convenient for cleaning the parts including the body 3 and for replenishing (filling) the body 3 with the pet food F.

The caps 5 and 7 are preferably made of a resin material such as polypropylene (PP) or polyethylene (PE), but are not limited thereto. Preferably, the caps 5 and 7 are more rigid than the body 3 and do not deform as easily as the body 3. Note that when the caps 5 and 7 are attached to the body 3, the opening positions of the holes 51 and 71 may face in opposite directions. That is, when the caps 5 and 7 are attached to the body 3, the screw threads 35 and 37 and the thread grooves 55 and 75 may be configured so that the opening positions of the holes 51 and 71 are opposite to each other. This makes it easy to select the hole 51 or hole 71 from which the pet food F is to be released during use.

Alternatively, a cap having a plurality of holes may be used instead of the caps 5 and 7 or together with the caps 5 and 7 (see FIG. 4(A) to FIG. 5(C)).

For example, in the embodiment shown in FIGS. 4(A) to 4(C), the cap 15 has holes 151 and 153. In this embodiment, the holes 151 and 153 have the same diameter, but the holes 151 and 153 may have different diameters. The cover 155 can selectively cover one of the holes 151 and 153, for example, by sliding between the holes 151 and 153.

Further, in the embodiment shown in FIGS. 5(A) to 5(C), the cap 25 has holes 251 and 253. In this embodiment, the holes 251 and 253 have the same diameter, which is smaller than the diameter of the holes 151 and 153, but the holes 251 and 253 may have different diameters. The cover 255 can selectively cover one of the holes 251 and 253, for example, by sliding between the holes 251 and 253.

By using the caps 15 and 25, the particle size and amount of the pet food F released from the body 3 can be adjusted more finely.

Next, how to use the pet toy 1 will be explained.

At least one of the caps 5, 7 is removed from the body 3 (see FIG. 1(B)).

The pet food F is put into the body 3 through the openings 31, 33, and the caps 5, 7 are attached to the body 3 again. At the same time, it is determined whether to cover the holes 51, 71 with the covers 53, 73 (see FIG. 2(A) to FIG. 3(D)).

Alternatively, the cap 15 (or the cap 25) may be attached in place of the caps 5, 7 (see FIG. 4(A) to FIG. 5(C)). In this case, it is determined which of the holes 151, 153 (or the holes 251, 253) will be covered with the cover 155 (or the cover 255).

Then, let the pet P play with the pet toy 1.

That is, when the pet P touches the pet toy 1, the body 3 rotates or locomotes. Here, as shown in FIG. 6(A), there are two types of rotation, i.e. rotation around the axis X of the body 3 (an axis extending in the direction connecting the caps 5, 7), and rotation around an axis Y perpendicular to the axis X of the body 3, either of which is good. With these movements, the pet food F makes noises inside the body 3, which attracts the interest of the pet P.

When the body 3 moves as described above, the pet food F inside the body 3 is released from at least one of the caps 5, 7 (see FIG. 6(B)). The released amount of the pet food F changes depending on how the body 3 moves. Further, since the diameter of the released pet food F differs depending on which hole 51, 71 the pet food F is released from, the manner of which the pet food F pops out differs. In particular, when the pet toy 1 rotates around the axis Y, centrifugal force acts on the pet food F inside the body 3, and it is likely to be released from the caps 5, 7.

The pet P can enjoy the movement of the pet toy 1 and the pet food F as described above, and at the same time, appetite of the pet P is satisfied by eating the released pet food F. Therefore, the pet toy 1 can also be called a toy and feeder or a pet toy with a feeding function.

When the pet P wants to eat the pet food F more, the pet moves and rotates the pet toy 1, and learns how to release more pet food F as the pet wants. That is, the pet toy 1 is useful for educational purposes.

At this time, by opening and closing the holes 51, 71 with the covers 53, 73, or, when the caps 15, 25 are used, by selecting the holes 151, 153, 251, 253, the diameter and amount of the released pet food F can be adjusted. Therefore, since various difficulty levels can be set by operating the switches on the caps 5, 7, it is possible to provide the pet P with a variety of ways to play. Further, it is also possible to prevent the pet P from eating too much of the pet food F, and to appropriately manage the health of the pet P.

Note that after using the pet toy 1, the caps 5, 7 (or the caps 15, 25) can be removed to wash the pet toy 1.

Although specific aspects of the pet toy according to the typical embodiment of the present invention have been described above, the present invention is not limited thereto, and various design changes are possible. Such matters relating to the design changes are also included in the technical scope of the present invention.

For example, the body 3 may have three or more openings. In this case, each opening may be fitted with a cap having holes of the same or different diameters, or with a different number of holes.

### EXPLANATION OF SYMBOLS

1 Pet toy
3 Body
31, 33 Opening
5, 7, 15, 25 Cap
51, 71, 151, 153, 251, 253 Hole
53, 73, 155, 255 Cover
F Pet food
P Pet

What I claim is:

1. A pet toy characterized by comprising:
a body having a first opening and a second opening and accommodating a pet food,
a first cap attached to the first opening and having a first hole, and
a second cap attached to the second opening and having a second hole;
wherein the pet food in the body is released from at least one of the first cap and the second cap when rotating or locomoting the body.

2. The pet toy according to claim 1, wherein the body is approximately cylindrical, and
the first opening and the second opening are located at both ends of the body.

3. The pet toy according to claim 1, wherein the first cap has a first cover that freely opens and closes the first hole.

4. The pet toy according to claim 3, wherein the second cap has a second cover that freely opens and closes the second hole.

5. The pet toy according to claim 4, wherein the first cap further has a third hole, and
the first cover selectively covers one of the first hole and the third hole.

6. The pet toy according to claim 5, wherein the second cap further has a fourth hole, and
the second cover selectively covers one of the second hole and the fourth hole.
